(19) United States
(12) Patent Application Publication
(10) Pub. No.: US 2024/0381208 A1
(43) Pub. Date: Nov. 14, 2024

(54) TECHNIQUES FOR USER EQUIPMENT INITIATED HANDOVER

(71) Applicant: QUALCOMM Incorporated, San Diego, CA (US)

(72) Inventors: Navid ABEDINI, Basking Ridge, NJ (US); Naeem AKL, Bridgewater, NJ (US); Jelena DAMNJANOVIC, Del Mar, CA (US); Sherif ELAZZOUNI, San Diego, CA (US)

(21) Appl. No.: 18/315,331

(22) Filed: May 10, 2023

(51) Int. Cl. H04W 36/30; H04W 36/00

(52) U.S. Cl. CPC H04W 36/30; H04W 36/00835

(57) ABSTRACT

Various aspects of the present disclosure generally relate to wireless communication. In some aspects, a user equipment (UE) may receive an indication, configuration, or adaptation of a triggering condition. The UE may evaluate a performance effect based, at least in part, on the triggering condition. The UE may initiate a handover procedure from a source cell to a target cell based, at least in part, on the performance effect. Numerous other aspects are described.

### FIELD OF THE DISCLOSURE

Aspects of the present disclosure generally relate to wireless communication and to techniques and apparatuses for a handover procedure initiated by a user equipment.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a user equipment (UE) for wireless communication. The user equipment may include one or more memories and one or more processors coupled to the one or more memories. The one or more processors may be individually or collectively configured to receive an indication, configuration, or adaptation of a triggering condition. The one or more processors may be individually or collectively configured to evaluate a performance effect based, at least in part, on the triggering condition. The one or more processors may be individually or collectively configured to initiate a handover procedure from a source cell to a target cell based, at least in part, on the performance effect.

Some aspects described herein relate to a network node for wireless communication. The network node may include one or more memories and one or more processors coupled to the one or more memories. The one or more processors may be individually or collectively configured to configure a UE to receive an indication, configuration, or adaptation of a triggering condition. The one or more processors may be individually or collectively configured to configure the UE to evaluate a performance effect based, at least in part, on the triggering condition. The one or more processors may be individually or collectively configured to configure the UE to initiate a handover procedure of the UE from a source cell to a target cell based, at least in part, on the performance effect.

Some aspects described herein relate to a method of wireless communication performed by a UE. The method may include receiving an indication, configuration, or adaptation of a triggering condition. The method may include evaluating a performance effect based, at least in part, on the triggering condition. The method may include initiating a handover procedure from a source cell to a target cell based, at least in part, on the performance effect.

Some aspects described herein relate to a method of wireless communication performed by a network node. The method may include configuring a UE to receive an indication, configuration, or adaptation of a triggering condition. The method may include configuring the UE to evaluate a performance effect based, at least in part, on the triggering condition. The method may include configuring the UE to initiate a handover procedure of the UE from a source cell to a target cell based, at least in part, on the performance effect.

Some aspects described herein relate to a non-transitory computer-readable medium that stores a set of instructions for wireless communication by a UE. The set of instructions, when executed by one or more processors of the UE, may cause the UE to receive an indication, configuration, or adaptation of a triggering condition. The set of instructions, when executed by one or more processors of the UE, may cause the UE to evaluate a performance effect based, at least in part, on the triggering condition. The set of instructions, when executed by one or more processors of the UE, may cause the UE to initiate a handover procedure from a source cell to a target cell based, at least in part, on the performance effect.

Some aspects described herein relate to a non-transitory computer-readable medium that stores a set of instructions for wireless communication by a network node. The set of instructions, when executed by one or more processors of the network node, may cause the network node to configure a UE to receive an indication, configuration, or adaptation of a triggering condition. The set of instructions, when executed by one or more processors of the network node, may cause the network node to configure the UE to evaluate a performance effect based, at least in part, on the triggering condition. The set of instructions, when executed by one or more processors of the network node, may cause the network node to configure the UE to initiate a handover procedure of the UE from a source cell to a target cell based, at least in part, on the performance effect.

Some aspects described herein relate to an apparatus for wireless communication. The apparatus may include means for receiving an indication, configuration, or adaptation of a triggering condition. The apparatus may include means for evaluating a performance effect based, at least in part, on the triggering condition. The apparatus may include means for initiating a handover procedure from a source cell to a target cell based, at least in part, on the performance effect.

Some aspects described herein relate to an apparatus for wireless communication. The apparatus may include means for configuring a UE to receive an indication, configuration, or adaptation of a triggering condition. The apparatus may include means for configuring the UE to evaluate a performance effect based, at least in part, on the triggering condition. The apparatus may include means for configuring the UE to initiate a handover procedure of the UE from a source cell to a target cell based, at least in part, on the performance effect.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of make-before-break handover, in accordance with the present disclosure.

FIG. 5 is a diagram illustrating an example of a discontinuous reception (DRX) configuration, in accordance with the present disclosure.

FIG. 6 is a diagram illustrating an example of a discontinuous transmission (DTX) configuration, in accordance with the present disclosure.

FIG. 7 is a diagram illustrating an example associated with a UE-initiated handover procedure, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

A handover (also referred to as cell switching) refers to the process of a user equipment (UE) transitioning from a source cell (e.g., a serving cell) to a target cell, sometimes as a result of movement of the UE. To execute a handover, the UE, the source cell, and the target cell engage in a handover procedure. The handover of the UE from the source cell to the target cell may be initiated through a series of events and measurements involving both the UE and a source cell. For example, the source cell may initiate the handover to the target node if quality of service (QOS) requirements, among other examples, would be improved by the handover of the UE to the target cell. To initiate the handover, the source cell may allocate resources for the UE to switch to the target cell for future communications.

In some instances, a network node may require a UE to operate in a discontinuous transmission (DTX) and/or discontinuous reception (DRX) (DTX/DRX) mode to save power. With DTX, the UE temporarily stops transmitting data during, for example, periods of inactivity. With DRX, the UE temporarily stops receiving data during predefined periods of inactivity configured by the network node. Both DTX and DRX can reduce power consumption by the UE.

The ability to initiate the handover procedure, as well as control over the UE operating in the DTX/DRX mode, rests with the network node. There may be circumstances, however, in which the network node requires the UE to operate in the DTX/DRX mode to conserve power even though the UE has, for example, particular QoS requirements or other circumstances, possibly unknown to the source cell, that would be negatively impacted by having the UE operate in the DTX/DRX mode.

Various aspects relate generally to a handover procedure initiated by a UE. Some aspects more specifically relate to the UE initiating a handover procedure based on certain triggering conditions. In some examples, a user equipment receives an indication, configuration, or adaptation of a triggering condition; evaluates a performance effect based, at least in part, on the triggering condition; and initiates a handover procedure from a source cell to a target cell based, at least in part, on the performance effect. In some examples, a network node configures a UE to receive an indication, configuration, or adaptation of a triggering condition; configures the UE to evaluate a performance effect based, at least in part, on the triggering condition; and configures the UE to initiate a handover procedure of the UE from a source cell to a target cell based, at least in part, on the performance effect.

Particular aspects of the subject matter described in this disclosure can be implemented to realize one or more of the following potential advantages. In some examples, by initiating the handover procedure from the source cell to the target cell based, at least in part, on the performance effect caused by the triggering condition, the described techniques can be used by the UE help the UE avoid restrictions, imposed by the network node, that would negatively impact the operation of the UE. In some examples, by configuring the UE to initiate the handover procedure of the UE from the source cell to the target cell based, at least in part, on the performance effect, the described techniques can be used to allow the UE to decide whether to stay on the source cell or transition to a target cell that will not require the UE to operate in, for example, a DTX/DRX mode that could negatively impact the UE's performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

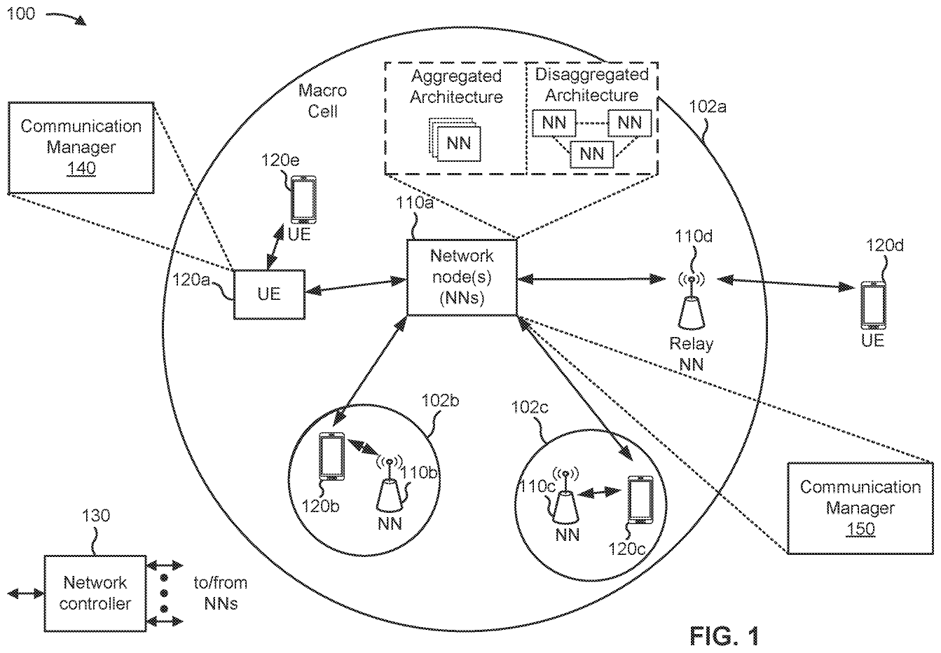

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHZ-7.125 GHz) and FR2 (24.25 GHZ-52.6 GHZ). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHZ-114.25 GHZ), and FR5 (114.25 GHZ-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive an indication, configuration, or adaptation of a triggering condition; evaluate a performance effect based, at least in part, on the triggering condition; and initiate a handover procedure from a source cell to a target cell based, at least in part, on the performance effect. Additionally, or alternatively, the communication manager 140 may perform one or more other operations described herein.

In some aspects, the network node 110 may include a communication manager 150. As described in more detail elsewhere herein, the communication manager 150 may configure a UE to receive an indication, configuration, or adaptation of a triggering condition; configure the UE to evaluate a performance effect based, at least in part, on the triggering condition; and configure the UE to initiate a handover procedure of the UE from a source cell to a target cell based, at least in part, on the performance effect. Additionally, or alternatively, the communication manager 150 may perform one or more other operations described herein.

As indicated above, FIG. 1 is provided as an example. Other examples may differ from what is described with regard to FIG. 1.

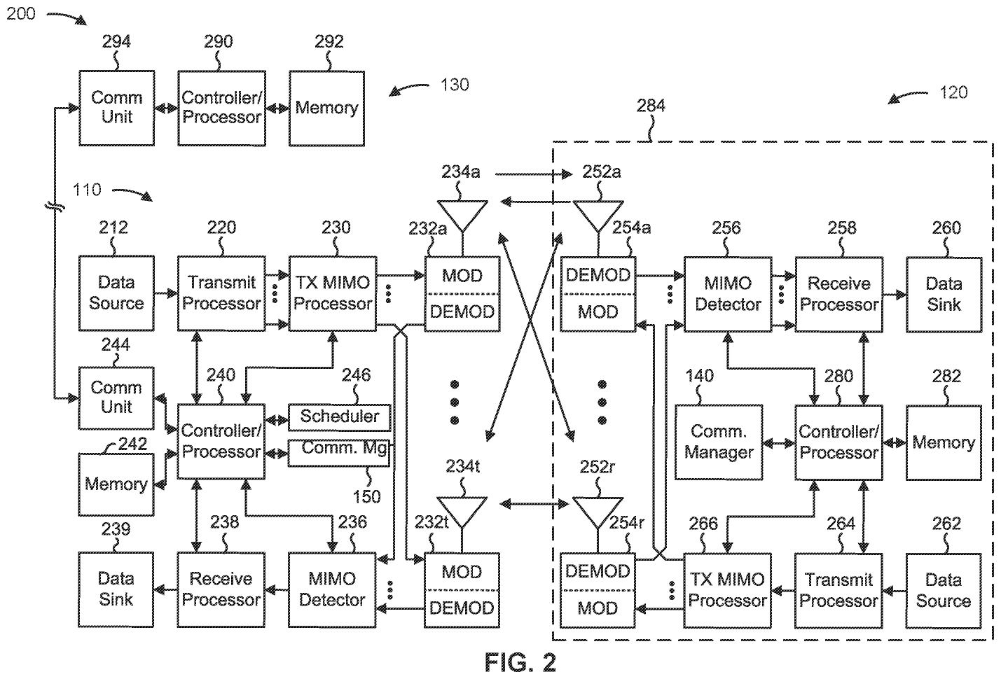

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

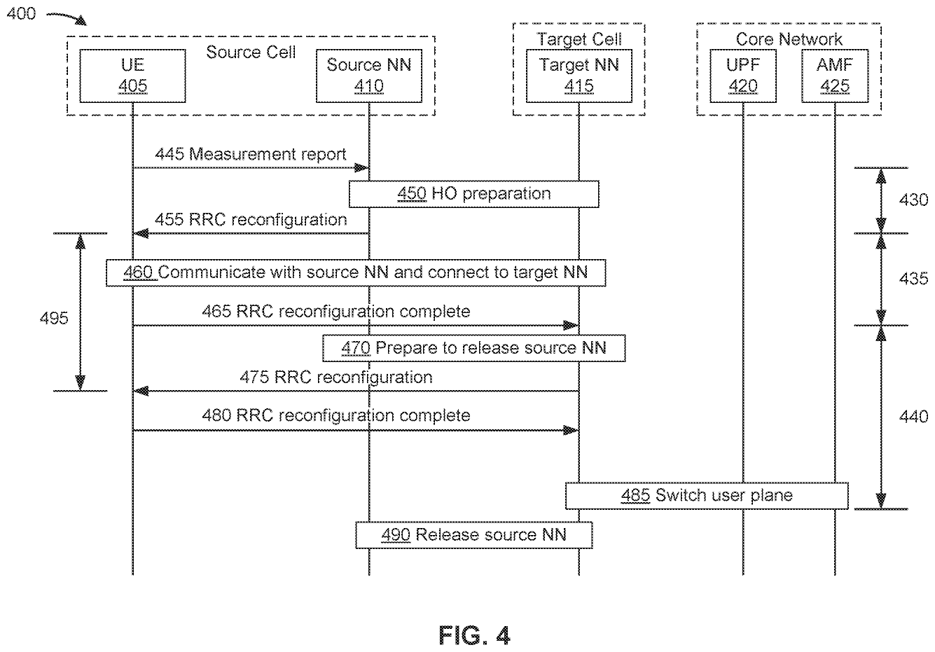

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-11).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-11).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

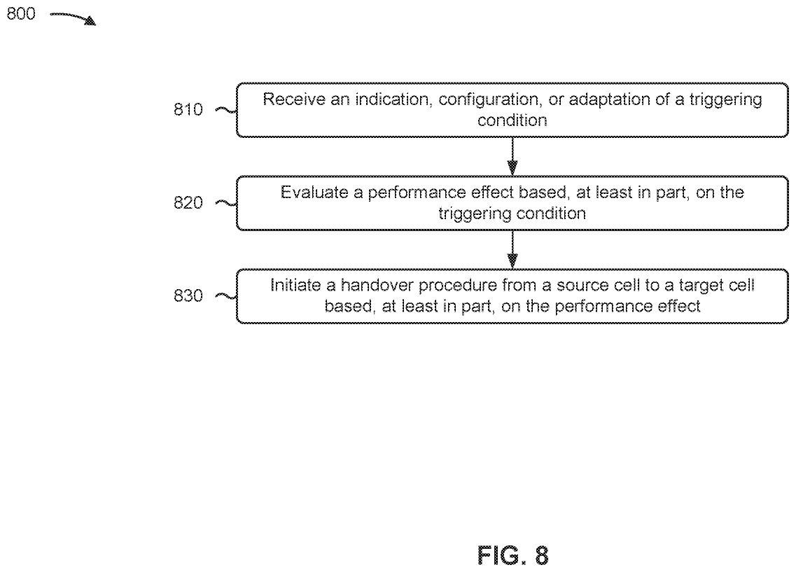

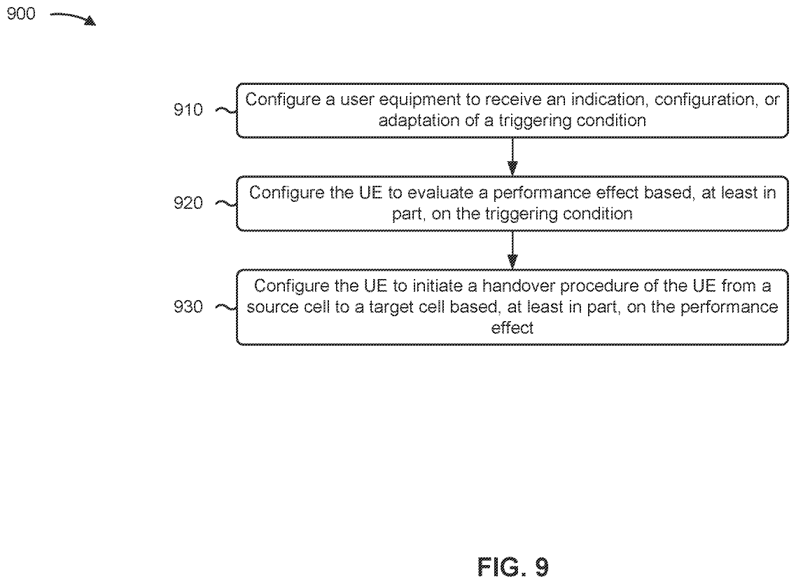

The controller/processor 240 of the network node 110, the controller/processor 280 of the UE 120, or any other component(s) of FIG. 2 may perform one or more techniques associated with a UE-initiated handover procedure, as described in more detail elsewhere herein. For example, the controller/processor 240 of the network node 110, the controller/processor 280 of the UE 120, or any other component(s) (or combinations of components) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE includes means for receiving an indication, configuration, or adaptation of a triggering condition; means for evaluating a performance effect based, at least in part, on the triggering condition; and/or means for initiating a handover procedure from a source cell to a target cell based, at least in part, on the performance effect. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for configuring a UE to receive an indication, configuration, or adaptation of a triggering condition; means for configuring the UE to evaluate a performance effect based, at least in part, on the triggering condition; and/or means for configuring the UE to initiate a handover procedure of the UE from a source cell to a target cell based, at least in part, on the performance effect. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

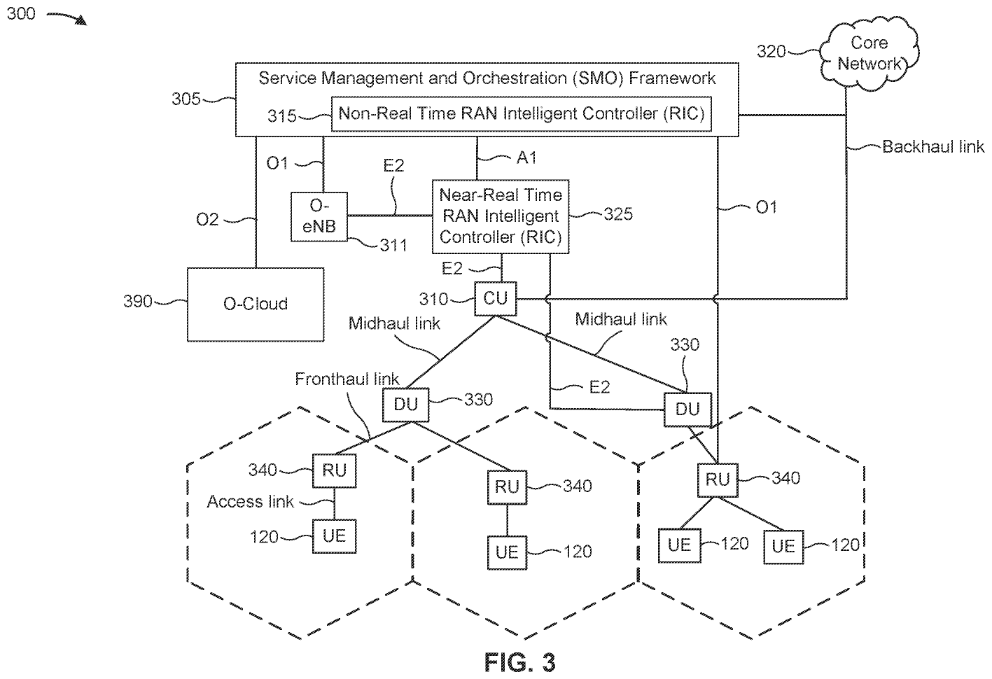

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of make-before-break handover, in accordance with the present disclosure.

As shown in FIG. 4, a make-before-break (MBB) handover procedure may involve a UE 405, a source network node 410, a target network node 415, a user plane function (UPF) device 420, and an access and mobility management function (AMF) device 425. In some examples, actions described as being performed by a network node may be performed by multiple different network nodes. For example, configuration actions and/or core network communication actions may be performed by a first network node (e.g., a CU or a DU), and radio communication actions may be performed by a second network node (e.g., a DU or an RU). The UE 405 may correspond to the UE 120 described elsewhere herein. The source network node 410 and/or the target network node 415 may correspond to the network node 110 described elsewhere herein. The UPF device 420 and/or the AMF device 425 may correspond to the network controller 130 described elsewhere herein. The UE 405 and the source network node 410 may be connected (e.g., may have an RRC connection) via a serving cell or a source cell, and the UE 405 may undergo a handover to the target network node 415 via a target cell. The UPF device 420 and/or the AMF device 425 may be located within a core network. The source network node 410 and the target network node 415 may be in communication with the core network for mobility support and user plane functions. The MBB handover procedure may include an enhanced MBB (eMBB) handover procedure.

As shown, the MBB handover procedure may include a handover preparation phase 430, a handover execution phase 435, and a handover completion phase 440. During the handover preparation phase 430, the UE 405 may report measurements or receive an indication, configuration, or adaptation of a triggering condition that may cause the UE 405, the source network node 410, and/or the target network node 415 to prepare for handover and trigger execution of the handover. During the handover execution phase 435, the UE 405 may execute the handover by performing a random access procedure with the target network node 415 and establishing an RRC connection with the target network node 415. During the handover completion phase 440, the source network node 410 may forward stored communications associated with the UE 405 to the target network node 415, and the UE 405 may be released from a connection with the source network node 410.

As shown by reference number 445, the UE 405 may perform one or more measurements, and may transmit a measurement report to the source network node 410 based at least in part on performing the one or more measurements (e.g., serving cell measurements and/or neighbor cell measurements). The measurement report may indicate, for example, an RSRP parameter, an RSRQ parameter, an RSSI parameter, and/or a signal-to-interference-plus-noise-ratio (SINR) parameter (e.g., for the serving cell and/or one or more neighbor cells). The source network node 410 may use the measurement report to determine whether to trigger a handover to the target network node 415. For example, if one or more measurements satisfy a condition, then the source network node 410 may trigger a handover of the UE 405 to the target network node 415. Alternatively, as discussed in greater detail below, the handover procedure may be initiated by the UE 405 as a result of the indication, configuration, or adaptation of the triggering condition. The triggering condition may occur, for example, as a result of the source network node 410 outputting a signal for a configuration, activation, or adaptation of a DTX/DRX mode to the UE 405.

As shown by reference number 450, the source network node 410 and the target network node 415 may communicate with one another to prepare for a handover of the UE 405. As part of the handover preparation, the source network node 410 may transmit a handover request to the target network node 415 to instruct the target network node 415 to prepare for the handover. The source network node 410 may communicate RRC context information associated with the UE 405 and/or configuration information associated with the UE 405 to the target network node 415. The target network node 415 may prepare for the handover by reserving resources for the UE 405. After reserving the resources, the target network node 415 may transmit an acknowledgement (ACK) to the source network node 410 in response to the handover request.

As shown by reference number 455, the source network node 410 may transmit an RRC reconfiguration message to the UE 405. The RRC reconfiguration message may include a handover command instructing the UE 405 to execute a handover procedure from the source network node 410 to the target network node 415. The handover command may include information associated with the target network node 415, such as a random access channel (RACH) preamble assignment for accessing the target network node 415. Reception of the RRC reconfiguration message, including the handover command, by the UE 405 may trigger the start of the handover execution phase 435.

As shown by reference number 460, during the handover execution phase 435 of the MBB handover, the UE 405 may execute the handover by performing a random access procedure with the target network node 415 (e.g., including synchronization with the target network node 415) while continuing to communicate with the source network node 410. For example, while the UE 405 is performing the random access procedure with the target network node 415, the UE 405 may transmit uplink data, uplink control information, and/or an uplink reference signal (e.g., a sounding reference signal) to the source network node 410, and/or may receive downlink data, downlink control information, and/or a downlink reference signal from the source network node 410.

As shown by reference number 465, upon successfully establishing a connection with the target network node 415 (e.g., via a random access procedure), the UE may transmit an RRC reconfiguration completion message to the target network node 415. Reception of the RRC reconfiguration message by the target network node 415 may trigger the start of the handover completion phase 440.

As shown by reference number 470, the source network node 410 and the target network node 415 may communicate with one another to prepare for release of the connection between the source network node 410 and the UE 405. In some aspects, the target network node 415 may determine that a connection between the source network node 410 and the UE 405 is to be released, such as after receiving the RRC reconfiguration message from the UE 405. In this case, the target network node 415 may transmit a handover connection setup completion message to the source network node 410. The handover connection setup completion message may cause the source network node 410 to stop transmitting data to the UE 405 and/or to stop receiving data from the UE 405. Additionally, or alternatively, the handover connection setup completion message may cause the source network node 410 to forward communications associated with the UE 405 to the target network node 415 and/or to notify the target network node 415 of a status of one or more communications with the UE 405. For example, the source network node 410 may forward, to the target network node 415, buffered downlink communications (e.g., downlink data) for the UE 405 and/or uplink communications (e.g., uplink data) received from the UE 405.

Additionally, or alternatively, the source network node 410 may notify the target network node 415 regarding a PDCP status associated with the UE 405 and/or a sequence number to be used for a downlink communication with the UE 405.

As shown by reference number 475, the target network node 415 may transmit an RRC reconfiguration message to the UE 405 to instruct the UE 405 to release the connection with the source network node 410. Upon receiving the instruction to release the connection with the source network node 410, the UE 405 may stop communicating with the source network node 410. For example, the UE 405 may refrain from transmitting uplink communications to the source network node 410 and/or may refrain from monitoring for downlink communications from the source network node 410.

As shown by reference number 480, the UE may transmit an RRC reconfiguration completion message to the target network node 415 to indicate that the connection between the source network node 410 and the UE 405 is being released or has been released.

As shown by reference number 485, the target network node 415, the UPF device 420, and/or the AMF device 425 may communicate to switch a user plane path of the UE 405 from the source network node 410 to the target network node 415. Prior to switching the user plane path, downlink communications for the UE 405 may be routed through the core network to the source network node 410. After the user plane path is switched, downlink communications for the UE 405 may be routed through the core network to the target network node 415. Upon completing the switch of the user plane path, the AMF device 425 may transmit an end marker message to the source network node 410 to signal completion of the user plane path switch. As shown by reference number 490, the target network node 415 and the source network node 410 may communicate to release the source network node 410.

As part of the MBB handover procedure, the UE 405 may maintain simultaneous connections with the source network node 410 and the target network node 415 during a time period 495. The time period 495 may start at the beginning of the handover execution phase 435 (e.g., upon reception by the UE 405 of a handover command from the source network node 410) when the UE 405 performs a random access procedure with the target network node 415. The time period 495 may end upon release of the connection between the UE 405 and the source network node 410 (e.g., upon reception by the UE 405 of an instruction, from the target network node 415, to release the source network node 410). By maintaining simultaneous connections with the source network node 410 and the target network node 415, the handover procedure can be performed with zero or a minimal interruption to communications, thereby reducing latency.

As indicated above, FIG. 4 is provided as an example. Other examples may differ from what is described with respect to FIG. 4.

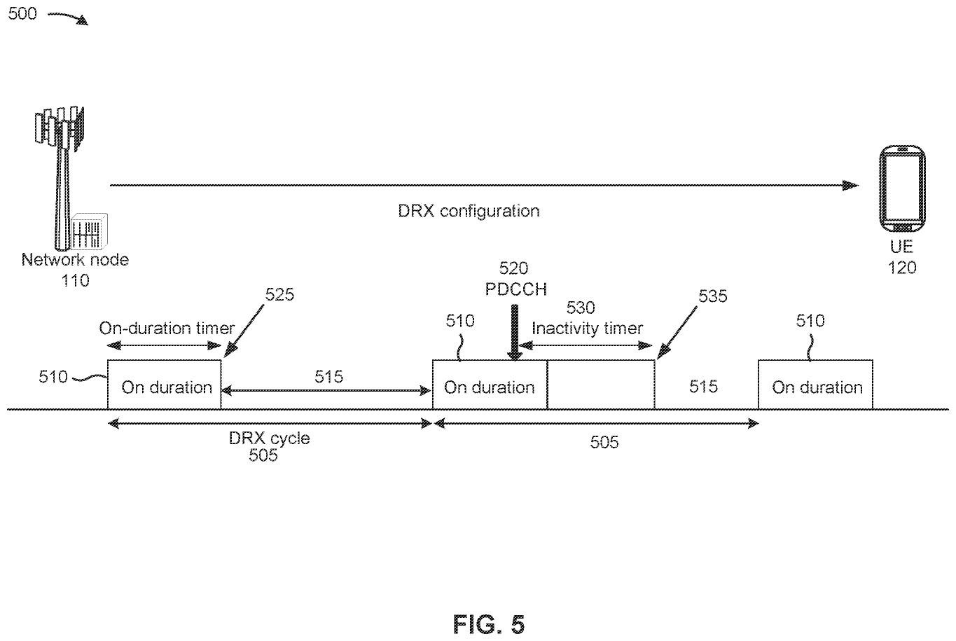

FIG. 5 is a diagram illustrating an example 500 of a DRX configuration, in accordance with the present disclosure.

As shown in FIG. 5, a network node 110 may transmit a DRX configuration to a UE 120 to configure a DRX cycle 505 for the UE 120. A DRX cycle 505 may include a DRX on duration 510 (e.g., during which a UE 120 is awake or in an active state) and an opportunity to enter a DRX sleep state 515. As used herein, the time during which the UE 120 is configured to be in an active state during the DRX on duration 510 may be referred to as an active time, and the time during which the UE 120 is configured to be in the DRX sleep state 515 may be referred to as an inactive time. As described below, the UE 120 may monitor a physical downlink control channel (PDCCH) during the active time and may refrain from monitoring the PDCCH during the inactive time.

During the DRX on duration 510 (e.g., the active time), the UE 120 may monitor a downlink control channel (e.g., a PDCCH), as shown by reference number 520. For example, the UE 120 may monitor the PDCCH for downlink control information (DCI) pertaining to the UE 120. If the UE 120 does not detect and/or successfully decode any PDCCH communications intended for the UE 120 during the DRX on duration 510, then the UE 120 may enter the sleep state 515 (e.g., for the inactive time) at the end of the DRX on duration 510, as shown by reference number 525. In this way, the UE 120 may conserve battery power and reduce power consumption. As shown, the DRX cycle 505 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 530 (e.g., which may extend the active time). The UE 120 may start the DRX inactivity timer 530 at a time at which the PDCCH communication is received (e.g., in a transmission time interval (TTI) in which the PDCCH communication is received, such as a slot or a subframe). The UE 120 may remain in the active state until the DRX inactivity timer 530 expires, at which time the UE 120 may enter the sleep state 515 (e.g., for the inactive time), as shown by reference number 535. During the duration of the DRX inactivity timer 530, the UE 120 may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a physical uplink shared channel (PUSCH)) scheduled by the PDCCH communication. The UE 120 may restart the DRX inactivity timer 530 after each detection of a PDCCH communication for the UE 120 for an initial transmission (e.g., but not for a retransmission). By operating in this manner, the UE 120 may conserve battery power and reduce power consumption by entering the sleep state 515.

As indicated above, FIG. 5 is provided as an example. Other examples may differ from what is described with respect to FIG. 5.

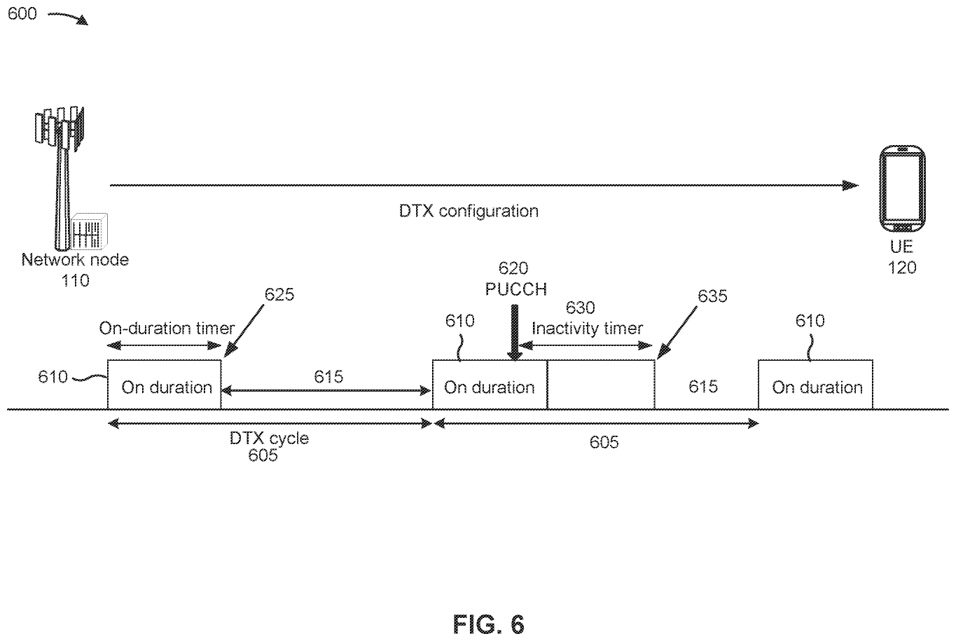

FIG. 6 is a diagram illustrating an example 600 of a DTX configuration, in accordance with the present disclosure.

As shown in FIG. 6, a network node 110 may transmit a DTX configuration to a UE 120 to configure a DTX cycle 605 for the UE 120. A DTX cycle 605 may include a DTX on duration 610 (e.g., during which a UE 120 is awake or in an active state) and an opportunity to enter a DTX sleep state 615. As used herein, the time during which the UE 120 is configured to be in an active state during the DTX on duration 610 may be referred to as an active time, and the time during which the UE 120 is configured to be in the DTX sleep state 615 may be referred to as an inactive time. As described below, the UE 120 may transmit on a physical uplink control channel (PUCCH) during the active time and may refrain from transmitting on the PUCCH during the inactive time.

During the DTX on duration 610 (e.g., the active time), the UE 120 may transmit on an uplink control channel (e.g., a PUCCH), as shown by reference number 620. For example, the UE 120 may transmit uplink control information (UCI) pertaining to the UE 120. If the UE 120 does not have any PUCCH communications scheduled or PUCCH resources configured during the DTX on duration 610, the UE 120 may enter the sleep state 615 (e.g., for the inactive time) at the end of the DTX on duration 610, as shown by reference number 625. In this way, the UE 120 may conserve battery power and reduce power consumption. As shown, the DTX cycle 605 may repeat with a configured periodicity according to the DTX configuration.

If the UE 120 transmits a PUCCH communication, the UE 120 may remain in an active state (e.g., awake) for the duration of a DTX inactivity timer 630 (e.g., which may extend the active time). The UE 120 may start the DTX inactivity timer 630 at a time at which the PUCCH communication is transmitted (e.g., in a TTI in which the PUCCH communication is transmitted, such as a slot or a subframe). The UE 120 may remain in the active state until the DTX inactivity timer 630 expires, at which time the UE 120 may enter the sleep state 615 (e.g., for the inactive time), as shown by reference number 635. During the duration of the DTX inactivity timer 630, the UE 120 may continue to transmit PUCCH communications, may prepare and transmit an uplink data communication (e.g., on an uplink data channel, such as a PUSCH) scheduled by the PDCCH communication. The UE 120 may restart the DTX inactivity timer 630 after each transmission (or retransmission) of a PUCCH communication. By operating in this manner, the UE 120 may conserve battery power and reduce power consumption by entering the sleep state 615.

As indicated above, FIG. 6 is provided as an example. Other examples may differ from what is described with respect to FIG. 6.

While DTX/DRX operation discussed above with respect to FIGS. 5 and 6 may help a UE 120 conserve energy, there are situations where negative impacts of the DTX/DRX configuration may outweigh the potential energy savings. Therefore, the UE 120 may be configured to initiate a handover procedure to a different candidate cell to, for example, avoid DTX/DRX configurations that may negatively impact the performance of the UE 120.

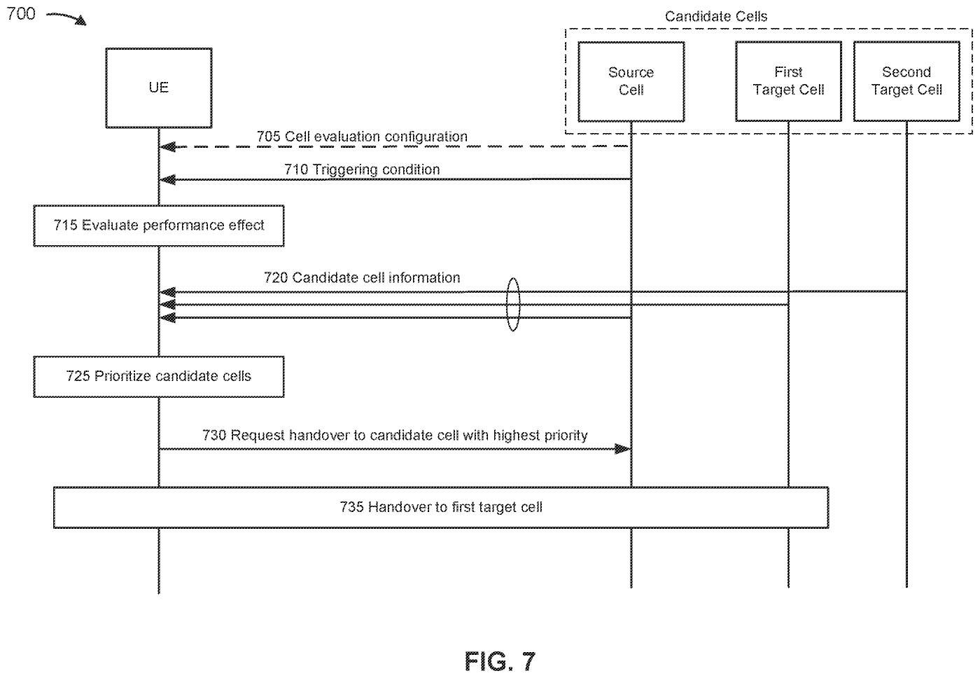

FIG. 7 is a diagram illustrating an example 700 associated with a UE-initiated handover procedure, in accordance with the present disclosure. As shown in FIG. 7, candidate cells (e.g., the source cell, a first target cell, and a second target cell) and a UE (such as UE 120) may communicate with one another. Two or more of the candidate cells may be part of the same or a different network node, such as network node 110. In some aspects, the source cell may be considered to be a candidate cell in addition to one or more target cells, such as the first target cell and/or the second target cell. Alternatively, the source cell may not be considered to be one of the candidate cells.

As shown by reference number 705, the network node may transmit, and the UE may receive, a cell evaluation configuration. In some aspects, the cell evaluation configuration may configure the UE to receive an indication, configuration, or adaptation of a triggering condition; evaluate a performance effect based, at least in part, on the triggering condition; and initiate a handover procedure of the UE from a source cell (such as a cell of source network node 410) to a target cell (such as a cell of target network node 415) based, at least in part, on the performance effect. In some aspects, the cell evaluation configuration may be included in the DRX configuration discussed above with respect to FIG. 5, the DTX configuration discussed above with respect to FIG. 6, and/or a combination thereof, among other examples. In some aspects, the cell evaluation configuration may be a different configuration than the DRX configuration and/or the DTX configuration.

As shown by reference number 710, the source cell may transmit, and the UE 120 may receive, a triggering signal (e.g., a configuration, indication, or adaptation (i.e., change)) with respect to a triggering condition. In some aspects, the triggering signal may alert the UE to the presence of the triggering condition. For example, the source cell may transmit, and the UE may receive, a triggering signal with a DTX/DRX configuration associated with communication via the source cell. In some aspects, the triggering signal may be received, by the UE, via a layer 1 indication or a layer 2 indication. In some aspects, the triggering signal may be transmitted by the source cell, and received by the UE, as a group-common layer 1 indication. In some aspects, the triggering signal may indicate a triggering condition with respect to one of the candidate cells other than the source cell (i.e., the first target cell or the second target cell). For example, in some aspects, the triggering signal may indicate that one or more of the first target cell or the second target cell has adopted dynamic DTX/DRX, and the UE may receive the DTX/DRX configuration associated with the dynamic DTX/DRX. In some aspects, the triggering signal may be received via one or more of dedicated signaling, group signaling, broadcast signaling, RRC signaling, MAC control element (MAC-CE) signaling, a paging communication, or a short message communication.

As shown by reference number 715, the UE may evaluate a performance effect based, at least in part, on the triggering condition. For example, evaluating the performance effect may include evaluating how the triggering condition may affect the QoS, signal strength, and/or a combination thereof, among other examples, associated with communication of the UE on the source cell as a result of the triggering condition. In some aspects, the UE may evaluate local information (e.g., information specific to and/or associated with the UE) to evaluate the performance effect. The local information may be stored in a memory of the UE and may or may not be available to the source cell. For example, in some aspects, the local information may include upcoming traffic or a QoS demand associated with the UE. In some aspects, upcoming traffic may refer to data traffic that the UE may be expected to transmit or receive. In some aspects, the UE may receive an indication from the source cell concerning whether or not to transition to communication over one of the target cells. In some aspects, the UE may be configured to execute any handover configuration received from the source cell regardless of how the handover will impact the performance effect. Alternatively, the UE may be configured to determine whether or not to transition to one of the target cells, regardless of indications or configurations received from the source cell, based on how the handover will impact the performance effect. Accordingly, in some aspects, the UE may be configured to ignore a handover configuration from the source cell if, for example, complying with the handover configuration will have a negative impact on the performance effect.

As shown by reference number 720, one or more of the candidate cells may transmit, and the UE may receive, candidate cell information. In some aspects, the candidate cell information may be included in a configuration report or a handover configuration. The candidate cell information may include information about, for example, cell DTX/DRX requirements of the candidate cells, including the serving cell (e.g., the source cell). For example, as discussed above, the cell information may include whether or not the first target cell, the second target cell, or both, adopt dynamic DTX/DRX. In some aspects, the candidate cell information may be received at the UE prior to receiving the handover configuration.

As shown by reference number 725, the UE may prioritize the candidate cells based, at least in part, on the candidate cell information. For example, the UE may prioritize the candidate cells based, at least in part, on one or more performance metrics (such as a cell DTX/DRX pattern, a cell DTX/DRX restrictions, upcoming traffic, QoS demands, and/or a combination thereof, among other examples) associated with communication on the respective candidate cell. In some aspects, the UE may prioritize the candidate cells according to the impact on the performance effect the UE may experience by transitioning to the candidate cell. For example, a candidate cell that offers the UE a higher QoS and/or signal strength may be assigned a higher priority than a candidate cell that offers the UE a lower QoS and/or signal strength. In some aspects, the UE may prioritize the candidate cells according to one or more prioritization rules. The prioritization rules may be based, at least in part, on the cell information, information about the UE, and/or a combination thereof, among other examples. For example, the prioritization rules may be based, at least in part, on one or more of a cell DTX/DRX configuration, a cell DTX/DRX pattern associated with a serving cell (e.g., the source cell), a cell DTX/DRX pattern associated with one or more neighboring cells (e.g., the first target cell and the second target cell) relative to the serving cell, upcoming traffic, a QoS demand, a mobility state relative to the two or more candidate cells, a direction of mobility, a power state, a signal strength associated with the two or more candidate cells, or a quality metric associated with the two or more candidate cells. Additional prioritization rules may include whether or how frequently the candidate cells are measured and/or whether the UE may be required to initiate a subsequent handover procedure, among other examples. The UE may receive the prioritization rules via a configuration or pre-configuration that includes one or more of the prioritization rules. In some aspects, the UE may select the target cell (e.g., the first target cell), from among the candidate cells, based, at least in part, on the priority assigned to each of the candidate cells. In some aspects, the target cell may be selected based, at least in part, on a DTX/DRX reception capability for each of the candidate cells.

As shown by reference number 730, the UE may initiate a handover procedure from the source cell to one of the candidate cells, such as the first target cell. In some aspects, the UE may transmit, and the source cell may receive, a handover request for a handover to the first target cell to initiate the handover procedure from the source cell to the first target cell. In some aspects, the UE may transmit, and the source cell may receive feedback, requesting the handover procedure, as a result of receiving the layer 1 indication or the layer 2 indication. In some aspects, the feedback may be included in a hybrid automatic repeat request acknowledgement (HARQ-ACK) transmitted from the UE to the source cell, and the HARQ-ACK may request the handover procedure.

As shown by reference number 735, the source cell, the first target cell, and the UE may execute the handover procedure similar to the handover procedure discussed above with reference to FIG. 4. In some aspects, the handover procedure may include a conditional handover (CHO), a lower-layer triggered mobility (LTM) handover, or a layer 3 handover (L3 HO). In some aspects, executing the handover procedure may include the source cell transmitting the handover configuration to the UE. In some aspects, the handover procedure may be based, at least in part, on a layer 3 signaled DTX/DRX configuration or a layer 3 signaled DTX/DRX reconfiguration. In some aspects, a handover configuration for the handover procedure may include a configuration for a conditional lower-layer triggered mobility handover based, at least in part, on a layer 1, layer 2, or layer 3 activation or deactivation indication of cell DTX/DRX.

In some aspects, the triggering condition for the conditional handover or conditional lower-layer triggered mobility may be further based on the cell DTX/DRX configuration, activation, deactivation, adaptation, and/or a combination thereof, among other examples, of neighboring target cells. In instances where the neighboring target cell adopts an adaptive or dynamic cell DTX/DRX, the UE may be provided with the cell DTX/DRX state (e.g., an updated or current configuration) of the neighboring cells. The cell DTX/DRX state of the neighboring cells may be provided to the UE via dedicated signaling, group-common signaling, broadcast signaling, layer 1 signaling, layer 2 signaling, layer 3 signaling, paging, short message communications, and/or a combination thereof, among other examples.

The exchange of cell DTX/DRX configuration information across backhaul interfaces (such as the F1-AP/Xn interfaces) may be challenging if the configuration changes dynamically. Therefore, the UE may be configured to consider target cells that can provide a longer-term commitment or prediction with respect to DTX/DRX. For example, the UE may be configured to consider candidate cells that do not perform dynamic DTX/DRX. For example, signaling may be exchanged over a backhaul interface (such as an F1-PA interface between a CU and DU and/or an Xn-AP interface between two CUs) to notify a DU or a neighboring CU about the cell DTX/DRX configuration. The information exchanged may include or reference a predicted or planned DTX/DRX configuration.

Accordingly, the UE can determine whether a triggering condition, such as an indication or configuration for DTX/DRX operation, will negatively impact the performance of the UE in a way that outweighs the energy savings associated with the DTX/DRX operation. If so, the UE can determine whether operation of the UE will be improved by transitioning to a target cell that, for example, will not require the DTX/DRX operation.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with techniques for a UE-initiated handover.

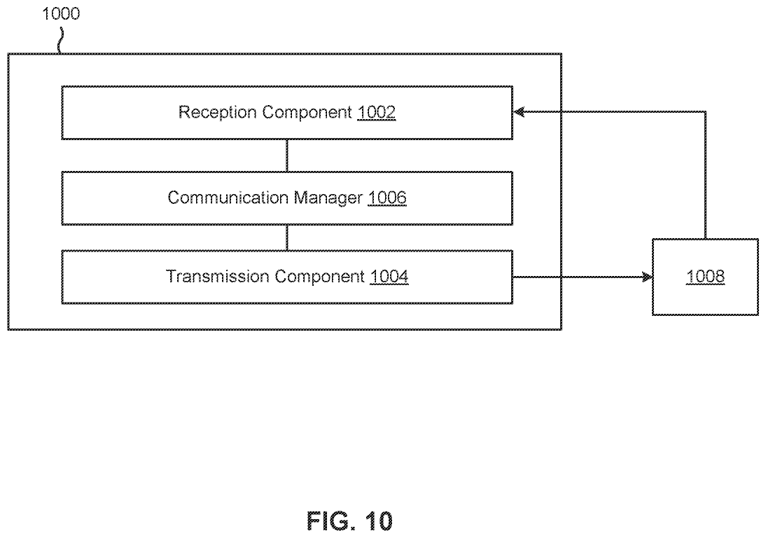

As shown in FIG. 8, in some aspects, process 800 may include receiving an indication, configuration, or adaptation of a triggering condition (block 810). For example, the UE (e.g., using reception component 1002 and/or communication manager 1006, depicted in FIG. 10) may receive an indication, configuration, or adaptation of a triggering condition, as described above.

As further shown in FIG. 8, in some aspects, process 800 may include evaluating a performance effect based, at least in part, on the triggering condition (block 820). For example, the UE (e.g., using communication manager 1006, depicted in FIG. 10) may evaluate a performance effect based, at least in part, on the triggering condition, as described above.

As further shown in FIG. 8, in some aspects, process 800 may include initiating a handover procedure from a source cell to a target cell based, at least in part, on the performance effect (block 830). For example, the UE (e.g., using communication manager 1006, depicted in FIG. 10) may initiate a handover procedure from a source cell to a target cell based, at least in part, on the performance effect, as described above.

Process 800 may include additional aspects, such as any single aspect or any combination of aspects described below and/or in connection with one or more other processes described elsewhere herein.

In a first aspect, receiving the indication, configuration, or adaptation of the triggering condition includes receiving an indication, configuration, or adaptation of DTX/DRX associated with one or more of the source cell or the target cell.

In a second aspect, alone or in combination with the first aspect, evaluating the performance effect includes evaluating a QoS associated with one or more of the source cell or the target cell.

In a third aspect, alone or in combination with one or more of the first and second aspects, evaluating the performance effect includes evaluating a strength of a signal transmitted by the source cell.

In a fourth aspect, alone or in combination with one or more of the first through third aspects, receiving the indication, configuration, or adaptation of the triggering condition includes receiving a layer 1 indication or a layer 2 indication.

In a fifth aspect, alone or in combination with one or more of the first through fourth aspects, initiating the handover procedure from the source cell to the target cell includes transmitting feedback, requesting the handover procedure, to the source cell as a result of receiving the layer 1 indication or the layer 2 indication.

In a sixth aspect, alone or in combination with one or more of the first through fifth aspects, transmitting the feedback includes transmitting a HARQ-ACK in response to the layer 1 indication or the layer 2 indication.

In a seventh aspect, alone or in combination with one or more of the first through sixth aspects, the HARQ-ACK includes a request for the handover procedure.

In an eighth aspect, alone or in combination with one or more of the first through seventh aspects, initiating the handover procedure from the source cell to the target cell includes transmitting a handover request to the source cell.

In a ninth aspect, alone or in combination with one or more of the first through eighth aspects, the handover procedure includes a conditional handover, a lower-layer triggered mobility handover, or a layer 3 handover.

In a tenth aspect, alone or in combination with one or more of the first through ninth aspects, the triggering condition includes a group-common layer 1 indication.

In an eleventh aspect, alone or in combination with one or more of the first through tenth aspects, evaluating the performance effect includes evaluating local information.

In a twelfth aspect, alone or in combination with one or more of the first through eleventh aspects, the local information includes upcoming traffic or a QoS demand.

In a thirteenth aspect, alone or in combination with one or more of the first through twelfth aspects, process 800 includes prioritizing two or more candidate cells, wherein the target cell is one of the two or more candidate cells and the source cell is one of the two or more candidate cells.

In a fourteenth aspect, alone or in combination with one or more of the first through thirteenth aspects, prioritizing the two or more candidate cells includes evaluating a performance metric associated with each of the two or more candidate cells.

In a fifteenth aspect, alone or in combination with one or more of the first through fourteenth aspects, the performance metric includes a cell DTX/DRX pattern, a cell DTX/DRX restriction, upcoming traffic, or QoS demand.

In a sixteenth aspect, alone or in combination with one or more of the first through fifteenth aspects, process 800 includes receiving cell information associated with one or more of the two or more candidate cells.

In a seventeenth aspect, alone or in combination with one or more of the first through sixteenth aspects, the cell information is received before a handover configuration is received.

In an eighteenth aspect, alone or in combination with one or more of the first through seventeenth aspects, the cell information is included in a configuration report.

In a nineteenth aspect, alone or in combination with one or more of the first through eighteenth aspects, the cell information is included in a handover configuration.

In a twentieth aspect, alone or in combination with one or more of the first through nineteenth aspects, prioritizing the two or more candidate cells is based, at least in part, on one or more prioritization rules.

In a twenty-first aspect, alone or in combination with one or more of the first through twentieth aspects, the one or more prioritization rules are based, at least in part, on one or more of a cell DTX/DRX configuration, a cell DTX/DRX pattern associated with a serving cell, a cell DTX/DRX pattern associated with one or more neighboring cells relative to the serving cell, upcoming traffic, a QoS demand, a mobility state relative to the two or more candidate cells, a direction of mobility, a power state, a signal strength associated with the two or more candidate cells, or a quality metric associated with the two or more candidate cells.

In a twenty-second aspect, alone or in combination with one or more of the first through twenty-first aspects, process 800 includes receiving a configuration or pre-configuration including the one or more prioritization rules.

In a twenty-third aspect, alone or in combination with one or more of the first through twenty-second aspects, the handover procedure is based, at least in part, on a layer 3 signaled DTX/DRX configuration or a layer 3 signaled DTX/DRX reconfiguration.

In a twenty-fourth aspect, alone or in combination with one or more of the first through twenty-third aspects, process 800 includes receiving a configuration for a conditional lower-layer triggered mobility handover based, at least in part, on a layer 1, layer 2, or layer 3 activation or deactivation indication of cell DTX/DRX.

In a twenty-fifth aspect, alone or in combination with one or more of the first through twenty-fourth aspects, the triggering condition is associated with one of the source cell or one or more candidate cells including the target cell.

In a twenty-sixth aspect, alone or in combination with one or more of the first through twenty-fifth aspects, process 800 includes receiving a triggering signal from one or more of the source cell or the one or more candidate cells, the triggering signal indicating a presence of the triggering condition.

In a twenty-seventh aspect, alone or in combination with one or more of the first through twenty-sixth aspects, the triggering signal is received via one or more of dedicated signaling, group signaling, broadcast signaling, radio resource control signaling, MAC-CE signaling, a paging communication, or a short message communication.

In a twenty-eighth aspect, alone or in combination with one or more of the first through twenty-seventh aspects, process 800 includes selecting the target cell from among the one or more candidate cells.

In a twenty-ninth aspect, alone or in combination with one or more of the first through twenty-eighth aspects, selecting the target cell is based, at least in part, on a dynamic DTX/DRX capability of each of the one or more candidate cells.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with techniques for a UE-initiated handover.

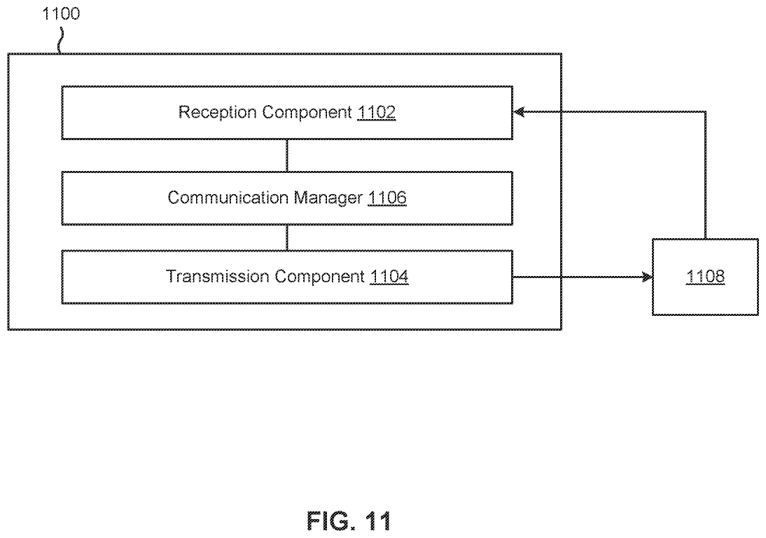

As shown in FIG. 9, in some aspects, process 900 may include configuring a UE to receive an indication, configuration, or adaptation of a triggering condition (block 910). For example, the network node (e.g., using communication manager 1106, depicted in FIG. 11) may configure a user equipment to receive an indication, configuration, or adaptation of a triggering condition, as described above.

As further shown in FIG. 9, in some aspects, process 900 may include configuring the UE to evaluate a performance effect based, at least in part, on the triggering condition (block 920). For example, the network node (e.g., using communication manager 1106, depicted in FIG. 11) may configure the UE to evaluate a performance effect based, at least in part, on the triggering condition, as described above.

As further shown in FIG. 9, in some aspects, process 900 may include configuring the UE to initiate a handover procedure of the UE from a source cell to a target cell based, at least in part, on the performance effect (block 930). For example, the network node (e.g., using communication manager 1106, depicted in FIG. 11) may configure the UE to initiate a handover procedure of the UE from a source cell to a target cell based, at least in part, on the performance effect, as described above.

In some aspects, configuring the UE to receive the indication, configuration, or adaptation of the triggering condition (block 910), configuring the UE to evaluate the performance effect based, at least in part, on the triggering condition (block 920), and configuring the UE to initiate the handover procedure of the UE from a source cell to a target cell based, at least in part, on the performance effect (block 930) may include the network node transmitting the cell evaluation configuration to the UE, as discussed above with respect to reference number 705 of FIG. 7.

Process 900 may include additional aspects, such as any single aspect or any combination of aspects described below and/or in connection with one or more other processes described elsewhere herein.

In a first aspect, configuring the UE to receive the indication, configuration, or adaptation of the triggering condition includes configuring the UE to receive an indication, configuration, or adaptation of DTX/DRX associated with one or more of the source cell or the target cell.

In a second aspect, alone or in combination with the first aspect, configuring the UE to evaluate the performance effect includes configuring the UE to evaluate a QoS associated with one or more of the source cell or the target cell.

In a third aspect, alone or in combination with one or more of the first and second aspects, configuring the UE to evaluate the performance effect includes configuring the UE to evaluate a strength of a signal transmitted by the source cell.

In a fourth aspect, alone or in combination with one or more of the first through third aspects, configuring the UE to receive the indication, configuration, or adaptation of the triggering condition includes configuring the UE to receive a layer 1 indication or a layer 2 indication.

In a fifth aspect, alone or in combination with one or more of the first through fourth aspects, configuring the UE to initiate the handover procedure from the source cell to the target cell includes configuring the UE to transmit feedback, requesting the handover procedure, to the source cell as a result of the UE receiving the layer 1 indication or the layer 2 indication.

In a sixth aspect, alone or in combination with one or more of the first through fifth aspects, configuring the UE to transmit the feedback includes configuring the UE to transmit a HARQ-ACK in response to the layer 1 indication or the layer 2 indication.

In a seventh aspect, alone or in combination with one or more of the first through sixth aspects, the HARQ-ACK includes a request for the handover procedure.

In an eighth aspect, alone or in combination with one or more of the first through seventh aspects, configuring the UE to initiate the handover procedure from the source cell to the target cell includes configuring the UE to transmit a handover request to the source cell.

In a ninth aspect, alone or in combination with one or more of the first through eighth aspects, the handover procedure includes a conditional handover, a lower-layer triggered mobility handover, or a layer 3 handover.

In a tenth aspect, alone or in combination with one or more of the first through ninth aspects, the triggering condition includes a group-common layer 1 indication.

In an eleventh aspect, alone or in combination with one or more of the first through tenth aspects, configuring the UE to evaluate the performance effect includes configuring the UE to evaluate local information.

In a twelfth aspect, alone or in combination with one or more of the first through eleventh aspects, the local information includes upcoming traffic or a QoS demand.

In a thirteenth aspect, alone or in combination with one or more of the first through twelfth aspects, process 900 includes configuring the UE to prioritize two or more candidate cells, wherein the target cell is one of the two or more candidate cells and the source cell is one of the two or more candidate cells.

In a fourteenth aspect, alone or in combination with one or more of the first through thirteenth aspects, configuring the UE to prioritize the two or more candidate cells includes configuring the UE to evaluate a performance metric associated with each of the two or more candidate cells.

In a fifteenth aspect, alone or in combination with one or more of the first through fourteenth aspects, the performance metric includes a cell DTX/DRX pattern, a cell DTX/DRX restriction, upcoming traffic, or QoS demand.

In a sixteenth aspect, alone or in combination with one or more of the first through fifteenth aspects, process 900 includes configuring the UE to receive cell information associated with one or more of the two or more candidate cells.

In a seventeenth aspect, alone or in combination with one or more of the first through sixteenth aspects, process 900 includes configuring the UE to receive the cell information before receiving a handover configuration.

In an eighteenth aspect, alone or in combination with one or more of the first through seventeenth aspects, the cell information is included in a configuration report.

In a nineteenth aspect, alone or in combination with one or more of the first through eighteenth aspects, the cell information is included in a handover configuration.

In a twentieth aspect, alone or in combination with one or more of the first through nineteenth aspects, configuring the UE to prioritize the two or more candidate cells is based, at least in part, on one or more prioritization rules.

In a twenty-first aspect, alone or in combination with one or more of the first through twentieth aspects, the one or more prioritization rules may be based, at least in part, on one or more of a cell DTX/DRX configuration, a cell DTX/DRX pattern associated with a serving cell, a cell DTX/DRX pattern associated with one or more neighboring cells relative to the serving cell, upcoming traffic, a QoS demand, a mobility state relative to the two or more candidate cells, a direction of mobility, a power state, a signal strength associated with the two or more candidate cells, or a quality metric associated with the two or more candidate cells.

In a twenty-second aspect, alone or in combination with one or more of the first through twenty-first aspects, process 900 includes configuring the UE to receive a configuration or pre-configuration including the one or more prioritization rules.

In a twenty-third aspect, alone or in combination with one or more of the first through twenty-second aspects, the handover procedure is based, at least in part, on a layer 3 signaled DTX/DRX configuration or a layer 3 signaled DTX/DRX reconfiguration.

In a twenty-fourth aspect, alone or in combination with one or more of the first through twenty-third aspects, process 900 includes configuring the UE to receive a configuration for a conditional lower-layer triggered mobility handover based, at least in part, on a layer 1, layer 2, or layer 3 activation or deactivation indication of cell DTX/DRX.

In a twenty-fifth aspect, alone or in combination with one or more of the first through twenty-fourth aspects, the triggering condition is associated with one of the source cell or one or more candidate cells including the target cell.

In a twenty-sixth aspect, alone or in combination with one or more of the first through twenty-fifth aspects, process 900 includes configuring the UE to receive a triggering signal from one or more of the source cell or the one or more candidate cells, the triggering signal indicating a presence of the triggering condition.

In a twenty-seventh aspect, alone or in combination with one or more of the first through twenty-sixth aspects, the triggering signal is received via one or more of dedicated signaling, group signaling, broadcast signaling, radio resource control signaling, MAC-CE signaling, a paging communication, or a short message communication.

In a twenty-eighth aspect, alone or in combination with one or more of the first through twenty-seventh aspects, process 900 includes configuring the UE to select the target cell from among the one or more candidate cells.

In a twenty-ninth aspect, alone or in combination with one or more of the first through twenty-eighth aspects, configuring the UE to select the target cell is based, at least in part, on a dynamic DTX/DRX capability of each of the one or more candidate cells.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive an indication, configuration, or adaptation of a triggering condition. The communication manager 1006 may evaluate a performance effect based, at least in part, on the triggering condition. The communication manager 1006 may initiate a handover procedure from a source cell to a target cell based, at least in part, on the performance effect.

The communication manager 1006 may prioritize two or more candidate cells, wherein the target cell is one of the two or more candidate cells and the source cell is one of the two or more candidate cells.

The reception component 1002 may receive cell information associated with one or more of the two or more candidate cells. The reception component 1002 may receive a configuration or pre-configuration including the one or more prioritization rules. The reception component 1002 may receive a configuration for a conditional lower-layer triggered mobility handover based, at least in part, on a layer 1, layer 2, or layer 3 activation or deactivation indication of cell DTX/DRX. The reception component 1002 may receive a triggering signal from one or more of the source cell or the one or more candidate cells, the triggering signal indicating a presence of the triggering condition.

The communication manager 1006 may select the target cell from among the one or more candidate cells.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The communication manager 1106 may configure a user equipment to receive an indication, configuration, or adaptation of a triggering condition. The communication manager 1106 may configure the UE to evaluate a performance effect based, at least in part, on the triggering condition. The communication manager 1106 may configure the UE to initiate a handover procedure of the UE from a source cell to a target cell based, at least in part, on the performance effect. The communication manager 1106 may configure the UE to prioritize two or more candidate cells, wherein the target cell is one of the two or more candidate cells and the source cell is one of the two or more candidate cells. The communication manager 1106 may configure the UE to receive cell information associated with one or more of the two or more candidate cells. The communication manager 1106 may configure the UE to receive the cell information before receiving a handover configuration. The communication manager 1106 may configure the UE to receive a configuration or pre-configuration including the one or more prioritization rules. The communication manager 1106 may configure the UE to receive a configuration for a conditional lower-layer triggered mobility handover based, at least in part, on a layer 1, layer 2, or layer 3 activation or deactivation indication of cell DTX/DRX. The communication manager 1106 may configure the UE to receive a triggering signal from one or more of the source cell or the one or more candidate cells, the triggering signal indicating a presence of the triggering condition. The communication manager 1106 may configure the UE to select the target cell from among the one or more candidate cells.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving an indication, configuration, or adaptation of a triggering condition; evaluating a performance effect based, at least in part, on the triggering condition; and initiating a handover procedure from a source cell to a target cell based, at least in part, on the performance effect.

Aspect 2: The method of Aspect 1, wherein receiving the indication, configuration, or adaptation of the triggering condition includes receiving an indication, configuration, or adaptation of DTX/DRX associated with one or more of the source cell or the target cell.

Aspect 3: The method of Aspect 2, wherein evaluating the performance effect includes evaluating a QoS associated with one or more of the source cell or the target cell.

Aspect 4: The method of Aspect 2, wherein evaluating the performance effect includes evaluating a strength of a signal transmitted by the source cell.

Aspect 5: The method of any of Aspects 1-4, wherein receiving the indication, configuration, or adaptation of the triggering condition includes receiving a layer 1 indication or a layer 2 indication.

Aspect 6: The method of Aspect 5, wherein initiating the handover procedure from the source cell to the target cell includes transmitting feedback, requesting the handover procedure, to the source cell as a result of receiving the layer 1 indication or the layer 2 indication.

Aspect 7: The method of Aspect 6, wherein transmitting the feedback includes transmitting a HARQ-ACK in response to the layer 1 indication or the layer 2 indication.

Aspect 8: The method of Aspect 7, wherein the HARQ-ACK includes a request for the handover procedure.

Aspect 9: The method of Aspect 5, wherein initiating the handover procedure from the source cell to the target cell includes transmitting a handover request to the source cell.

Aspect 10: The method of any of Aspects 1-9, wherein the handover procedure includes a conditional handover, a lower-layer triggered mobility handover, or a layer 3 handover.

Aspect 11: The method of any of Aspects 1-10, wherein the triggering condition includes a group-common layer 1 indication.

Aspect 12: The method of any of Aspects 1-11, wherein evaluating the performance effect includes evaluating local information.

Aspect 13: The method of Aspect 12, wherein the local information includes upcoming traffic or a QoS demand.

Aspect 14: The method of any of Aspects 1-13, further comprising prioritizing two or more candidate cells, wherein the target cell is one of the two or more candidate cells and the source cell is one of the two or more candidate cells.

Aspect 15: The method of Aspect 14, wherein prioritizing the two or more candidate cells includes evaluating a performance metric associated with each of the two or more candidate cells.

Aspect 16: The method of Aspect 15, wherein the performance metric includes a cell DTX/DRX pattern, a cell DTX/DRX restriction, upcoming traffic, or QoS demand.

Aspect 17: The method of Aspect 14, further comprising receiving cell information associated with one or more of the two or more candidate cells.

Aspect 18: The method of Aspect 17, wherein the cell information is received before a handover configuration is received.

Aspect 19: The method of Aspect 17, wherein the cell information is included in a configuration report.

Aspect 20: The method of Aspect 17, wherein the cell information is included in a handover configuration.

Aspect 21: The method of Aspect 14, wherein prioritizing the two or more candidate cells is based, at least in part, on one or more prioritization rules.

Aspect 22: The method of Aspect 21, wherein the one or more prioritization rules are based, at least in part, on one or more of a cell DTX/DRX configuration, a cell DTX/DRX pattern associated with a serving cell, a cell DTX/DRX pattern associated with one or more neighboring cells relative to the serving cell, upcoming traffic, a QoS demand, a mobility state relative to the two or more candidate cells, a direction of mobility, a power state, a signal strength associated with the two or more candidate cells, or a quality metric associated with the two or more candidate cells.

Aspect 23: The method of Aspect 21, further comprising receiving a configuration or pre-configuration including the one or more prioritization rules.

Aspect 24: The method of any of Aspects 1-23, wherein the handover procedure is based, at least in part, on a layer 3 signaled DTX/DRX configuration or a layer 3 signaled DTX/DRX reconfiguration.

Aspect 25: The method of any of Aspects 1-24, further comprising receiving a configuration for a conditional lower-layer triggered mobility handover based, at least in part, on a layer 1, layer 2, or layer 3 activation or deactivation indication of cell DTX/DRX.

Aspect 26: The method of any of Aspects 1-25, wherein the triggering condition is associated with one of the source cell or one or more candidate cells including the target cell.

Aspect 27: The method of Aspect 26, further comprising receiving a triggering signal from one or more of the source cell or the one or more candidate cells, the triggering signal indicating a presence of the triggering condition.

Aspect 28: The method of Aspect 27, wherein the triggering signal is received via one or more of dedicated signaling, group signaling, broadcast signaling, radio resource control signaling, MAC-CE signaling, a paging communication, or a short message communication.

Aspect 29: The method of Aspect 27, further comprising selecting the target cell from among the one or more candidate cells.

Aspect 30: The method of Aspect 29, wherein selecting the target cell is based, at least in part, on a dynamic DTX/DRX capability of each of the one or more candidate cells.

Aspect 31: A method of wireless communication performed by a network node, comprising: configuring a UE to receive an indication, configuration, or adaptation of a triggering condition; configuring the UE to evaluate a performance effect based, at least in part, on the triggering condition; and configuring the UE to initiate a handover procedure of the UE from a source cell to a target cell based, at least in part, on the performance effect.

Aspect 32: The method of Aspect 31, wherein configuring the UE to receive the indication, configuration, or adaptation of the triggering condition includes configuring the UE to receive an indication, configuration, or adaptation of DTX/DRX associated with one or more of the source cell or the target cell.

Aspect 33: The method of Aspect 32, wherein configuring the UE to evaluate the performance effect includes configuring the UE to evaluate a QoS associated with one or more of the source cell or the target cell.

Aspect 34: The method of Aspect 32, wherein configuring the UE to evaluate the performance effect includes configuring the UE to evaluate a strength of a signal transmitted by the source cell.

Aspect 35: The method of any of Aspects 31-34, wherein configuring the UE to receive the indication, configuration, or adaptation of the triggering condition includes configuring the UE to receive a layer 1 indication or a layer 2 indication.

Aspect 36: The method of Aspect 35, wherein configuring the UE to initiate the handover procedure from the source cell to the target cell includes configuring the UE to transmit feedback, requesting the handover procedure, to the source cell as a result of the UE receiving the layer 1 indication or the layer 2 indication.

Aspect 37: The method of Aspect 36, wherein configuring the UE to transmit the feedback includes configuring the UE to transmit a HARQ-ACK in response to the layer 1 indication or the layer 2 indication.

Aspect 38: The method of Aspect 37, wherein the HARQ-ACK includes a request for the handover procedure.

Aspect 39: The method of Aspect 35, wherein configuring the UE to initiate the handover procedure from the source cell to the target cell includes configuring the UE to transmit a handover request to the source cell.

Aspect 40: The method of any of Aspects 31-39, wherein the handover procedure includes a conditional handover, a lower-layer triggered mobility handover, or a layer 3 handover.

Aspect 41: The method of any of Aspects 31-40, wherein the triggering condition includes a group-common layer 1 indication.

Aspect 42: The method of any of Aspects 31-41, wherein configuring the UE to evaluate the performance effect includes configuring the UE to evaluate local information.

Aspect 43: The method of Aspect 42, wherein the local information includes upcoming traffic or a QoS demand.

Aspect 44: The method of any of Aspects 31-43, further comprising configuring the UE to prioritize two or more candidate cells, wherein the target cell is one of the two or more candidate cells and the source cell is one of the two or more candidate cells.

Aspect 45: The method of Aspect 44, wherein configuring the UE to prioritize the two or more candidate cells includes configuring the UE to evaluate a performance metric associated with each of the two or more candidate cells.

Aspect 46: The method of Aspect 45, wherein the performance metric includes a cell DTX/DRX pattern, a cell DTX/DRX restriction, upcoming traffic, or QoS demand.

Aspect 47: The method of Aspect 44, further comprising configuring the UE to receive cell information associated with one or more of the two or more candidate cells.

Aspect 48: The method of Aspect 47, further comprising configuring the UE to receive the cell information before receiving a handover configuration.

Aspect 49: The method of Aspect 47, wherein the cell information is included in a configuration report.

Aspect 50: The method of Aspect 47, wherein the cell information is included in a handover configuration.

Aspect 51: The method of Aspect 44, wherein configuring the UE to prioritize the two or more candidate cells is based, at least in part, on one or more prioritization rules.

Aspect 52: The method of Aspect 51, wherein the one or more prioritization rules may be based, at least in part, on one or more of a cell DTX/DRX configuration, a cell DTX/DRX pattern associated with a serving cell, a cell DTX/DRX pattern associated with one or more neighboring cells relative to the serving cell, upcoming traffic, a QoS demand, a mobility state relative to the two or more candidate cells, a direction of mobility, a power state, a signal strength associated with the two or more candidate cells, or a quality metric associated with the two or more candidate cells.

Aspect 53: The method of Aspect 51, further comprising configuring the UE to receive a configuration or pre-configuration including the one or more prioritization rules.

Aspect 54: The method of any of Aspects 31-53, wherein the handover procedure is based, at least in part, on a layer 3 signaled DTX/DRX configuration or a layer 3 signaled DTX/DRX reconfiguration.

Aspect 55: The method of any of Aspects 31-54, further comprising configuring the UE to receive a configuration for a conditional lower-layer triggered mobility handover based, at least in part, on a layer 1, layer 2, or layer 3 activation or deactivation indication of cell DTX/DRX.

Aspect 56: The method of any of Aspects 31-55, wherein the triggering condition is associated with one of the source cell or one or more candidate cells including the target cell.

Aspect 57: The method of Aspect 56, further comprising configuring the UE to receive a triggering signal from one or more of the source cell or the one or more candidate cells, the triggering signal indicating a presence of the triggering condition.

Aspect 58: The method of Aspect 57, wherein the triggering signal is received via one or more of dedicated signaling, group signaling, broadcast signaling, radio resource control signaling, MAC-CE signaling, a paging communication, or a short message communication.

Aspect 59: The method of Aspect 57, further comprising configuring the UE to select the target cell from among the one or more candidate cells.

Aspect 60: The method of Aspect 59, wherein configuring the UE to select the target cell is based, at least in part, on a dynamic DTX/DRX capability of each of the one or more candidate cells.

Aspect 61: An apparatus for wireless communication at a device, comprising a processor; memory coupled with the processor; and instructions stored in the memory and executable by the processor to cause the apparatus to perform the method of one or more of Aspects 1-60.

Aspect 62: A device for wireless communication, comprising a memory and one or more processors coupled to the memory, the one or more processors individually or collectively configured to perform the method of one or more of Aspects 1-60.

Aspect 63: An apparatus for wireless communication, comprising at least one means for performing the method of one or more of Aspects 1-60.

Aspect 64: A non-transitory computer-readable medium storing code for wireless communication, the code comprising instructions executable by a processor to perform the method of one or more of Aspects 1-60.

Aspect 65: A non-transitory computer-readable medium storing a set of instructions for wireless communication, the set of instructions comprising one or more instructions that, when executed by one or more processors of a device, cause the device to perform the method of one or more of Aspects 1-60.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A user equipment (UE) for wireless communication, comprising:
one or more memories; and
one or more processors, coupled to the one or more memories, individually or collectively configured to:
receive an indication, configuration, or adaptation of a triggering condition;
evaluate a performance effect based, at least in part, on the triggering condition; and
initiate a handover procedure from a source cell to a target cell based, at least in part, on the performance effect.

2. The UE of claim 1, wherein the one or more processors, to receive the indication, configuration, or adaptation of the triggering condition, are individually or collectively configured to receive an indication, configuration, or adaptation of discontinuous transmission/discontinuous reception (DTX/DRX) associated with one or more of the source cell or the target cell.

3. The UE of claim 2, wherein the one or more processors, to evaluate the performance effect, are individually or collectively configured to evaluate a quality of service associated with one or more of the source cell or the target cell.

4. The UE of claim 2, wherein the one or more processors, to evaluate the performance effect, are individually or collectively configured to evaluate a strength of a signal transmitted by the source cell, the target cell, or both.

5. The UE of claim 1, wherein the one or more processors, to receive the indication, configuration, or adaptation of the triggering condition, are individually or collectively configured to receive a layer 1 indication or a layer 2 indication.

6. The UE of claim 1, wherein the handover procedure includes a conditional handover, a lower-layer triggered mobility handover, or a layer 3 handover.

7. The UE of claim 1, wherein the triggering condition includes a group-common layer 1 indication.

8. The UE of claim 1, wherein the one or more processors, to evaluate the performance effect, are individually or collectively configured to evaluate local information.

9. The UE of claim 1, wherein the one or more processors are further individually or collectively configured to prioritize two or more candidate cells, wherein the target cell is one of the two or more candidate cells and the source cell is one of the two or more candidate cells.

10. The UE of claim 9, wherein the one or more processors, to prioritize the two or more candidate cells, are individually or collectively configured to evaluate a performance metric associated with each of the two or more candidate cells.

11. The UE of claim 9, wherein the one or more processors are further individually or collectively configured to receive cell information associated with one or more of the two or more candidate cells.

12. The UE of claim 9, wherein prioritizing the two or more candidate cells is based, at least in part, on one or more prioritization rules.

13. The UE of claim 1, wherein the handover procedure is based, at least in part, on a layer 3 signaled discontinuous transmission/discontinuous reception (DTX/DRX) configuration or a layer 3 signaled DTX/DRX reconfiguration.

14. The UE of claim 1, wherein the one or more processors are further individually or collectively configured to receive a configuration for a conditional lower-layer triggered mobility handover based, at least in part, on a layer 1, layer 2, or layer 3 activation or deactivation indication of cell discontinuous transmission/discontinuous reception.

15. The UE of claim 1, wherein the triggering condition is associated with one of the source cell or one or more candidate cells including the target cell.

16. The UE of claim 15, wherein the one or more processors are further individually or collectively configured to receive a triggering signal from one or more of the source cell or the one or more candidate cells, the triggering signal indicating a presence of the triggering condition.

17. The UE of claim 16, wherein the triggering signal is received via one or more of dedicated signaling, group signaling, broadcast signaling, radio resource control signaling, medium access control (MAC) control element signaling, a paging communication, or a short message communication.

18. The UE of claim 16, wherein the one or more processors are further individually or collectively configured to select the target cell from among the one or more candidate cells.

19. The UE of claim 18, wherein selecting the target cell is based, at least in part, on a dynamic discontinuous transmission/discontinuous reception capability of each of the one or more candidate cells.

20. A network node for wireless communication, comprising:
one or more memories; and
one or more processors, coupled to the one or more memories, individually or collectively configured to:
configure a user equipment (UE) to receive an indication, configuration, or adaptation of a triggering condition;
configure the UE to evaluate a performance effect based, at least in part, on the triggering condition; and
configure the UE to initiate a handover procedure of the UE from a source cell to a target cell based, at least in part, on the performance effect.

21. The network node of claim 20, wherein the one or more processors, to configure the UE to receive the indication, configuration, or adaptation of the triggering condition, are individually or collectively configured to configure the UE to receive an indication, configuration, or adaptation of discontinuous transmission/discontinuous reception (DTX/DRX) associated with one or more of the source cell or the target cell.

22. The network node of claim 20, wherein the one or more processors, to configure the UE to evaluate the performance effect, are individually or collectively configured to configure the UE to evaluate local information.

23. The network node of claim 20, wherein the one or more processors are further individually or collectively configured to configure the UE to prioritize two or more candidate cells, wherein the target cell is one of the two or more candidate cells and the source cell is one of the two or more candidate cells.

24. The network node of claim 20, wherein the one or more processors are further individually or collectively configured to configure the UE to receive a configuration for a conditional lower-layer triggered mobility handover based, at least in part, on a layer 1, layer 2, or layer 3 activation or deactivation indication of cell discontinuous transmission/discontinuous reception.

25. The network node of claim 20, wherein the triggering condition is associated with one of the source cell or one or more candidate cells including the target cell.

26. A method of wireless communication performed by a user equipment (UE), comprising:
receiving an indication, configuration, or adaptation of a triggering condition;
evaluating a performance effect based, at least in part, on the triggering condition; and
initiating a handover procedure from a source cell to a target cell based, at least in part, on the performance effect.

27. The method of claim 26, wherein receiving the indication, configuration, or adaptation of the triggering condition includes receiving an indication, configuration, or adaptation of discontinuous transmission/discontinuous reception (DTX/DRX) associated with one or more of the source cell or the target cell.

28. The method of claim 26, wherein evaluating the performance effect includes evaluating local information.

29. The method of claim 26, further comprising prioritizing two or more candidate cells, wherein the target cell is one of the two or more candidate cells and the source cell is one of the two or more candidate cells.

30. A method of wireless communication performed by a network node, comprising:
configuring a user equipment (UE) to receive an indication, configuration, or adaptation of a triggering condition;
configuring the UE to evaluate a performance effect based, at least in part, on the triggering condition; and
configuring the UE to initiate a handover procedure of the UE from a source cell to a target cell based, at least in part, on the performance effect.
